(19) United States
(12) Patent Application Publication
(10) Pub. No.: US 2022/0156380 A1
(43) Pub. Date: May 19, 2022

(54) SYSTEMS AND METHODS FOR INTELLIGENCE DRIVEN CONTAINER DEPLOYMENT

(71) Applicant: Cyber Reconnaissance, Inc., Tempe, AZ (US)

(72) Inventors: Piotr Pradzynski, Torun (PL); Aditya Shah, Chandler, AZ (US); Paulo Shakarian, Chandler, AZ (US); Jana Shakarian, Chandler, AZ (US)

(21) Appl. No.: 17/098,827

(22) Filed: Nov. 16, 2020

(51) Int. Cl. G06F 21/57; G06N 20/00; G06F 21/56

(52) U.S. Cl. CPC G06F 21/577; G06F 2221/034; G06F 21/566; G06N 20/00

(57) ABSTRACT

System and methods may detect and mitigate cybersecurity threats to containers. The systems may scan an image of the container using a vulnerability scanner to generate a scan result identifying a cybersecurity vulnerability present in the image. The System may receive threat-intelligence data from a threat intelligence source comprising a first set of information regarding a plurality of cybersecurity vulnerabilities in addition to ground-truth data from a ground-truth data source comprising a second set of information regarding the plurality of cybersecurity vulnerabilities. Ground truth data and threat-intelligence data may be aggregated to generate aggregated data identifying an exploit related to the cybersecurity vulnerability. The aggregated data may be aligned with the scan result to identify the exploit for the cybersecurity vulnerability. A mitigation action may inhibit the exploit from compromising the container, and the system may launch the container in response to performing the mitigating action.

### FIELD

The present disclosure generally relates to cyber security, and in particular to systems and methods for mitigating cyber security risks in container deployment.

### BACKGROUND

Virtual machines (VMs) allow a single computing device to run multiple operating systems and applications. The operating systems and applications running on VMs could be largely protected from traditional cybersecurity risks using traditional techniques. Virtual machines and the redundant software loaded to run them consume more resources. The tradeoff is performance in exchange for maintaining less hardware to accomplish the same tasks.

Containers were created to leverage the computing advantage of virtual machines without some of the overhead caused by running multiple virtual machines. Containers are applications. They are ephemeral in nature and can be rapidly deployed launched using images. The downside is that both using images and sharing resources can expose containers to cybersecurity threats. Running a container with a known vulnerability may subject software and data in the container to a heightened risk of compromise. However, a container is typically launched before scanning for vulnerabilities. An administrator is faced with a choice between launching before scanning or not launching at all.

### SUMMARY

Systems, methods, and devices (collectively, the “System”) of the present disclosure may scan an image of the container using a vulnerability scanner to generate a scan result identifying a cybersecurity vulnerability present in the image. The System may receive threat-intelligence data from a threat intelligence source comprising a first set of information regarding a plurality of cybersecurity vulnerabilities in addition to ground-truth data from a ground-truth data source comprising a second set of information regarding the plurality of cybersecurity vulnerabilities. The System may aggregate the ground-truth data and the threat-intelligence data to generate aggregated data identifying an exploit related to the cybersecurity vulnerability. The aggregated data may be aligned with the scan result to identify the exploit for the cybersecurity vulnerability. The System may perform a mitigation action to inhibit the exploit from compromising the container in response to identifying the exploit for the cybersecurity vulnerability, and then launch the container in response to performing the mitigating action.

The mitigation action performed by the System may comprise blocking a port associated with the exploit, disabling the software having the vulnerability from running in the container, substituting a replacement image for the image, or blocking an IP address. The System may select the mitigating action from a plurality of mitigating actions in response to the scan result and the aggregated data meeting administrator criteria associated with the mitigating action.

### BRIEF DESCRIPTION

The subject matter of the present disclosure is particularly pointed out and distinctly claimed in the concluding portion of the specification. A more complete understanding of the present disclosure, however, may best be obtained by referring to the detailed description and claims when considered in connection with the illustrations.

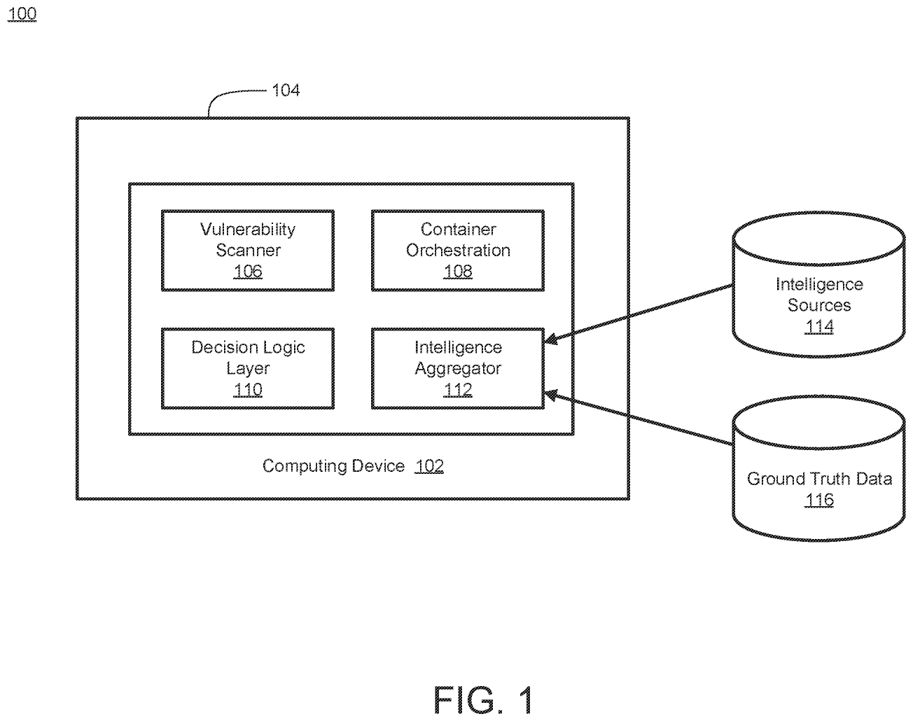

FIG. 1 illustrates a computer-based system for detecting vulnerabilities in containers and managing deployment to mitigate risk, in accordance with various embodiments;

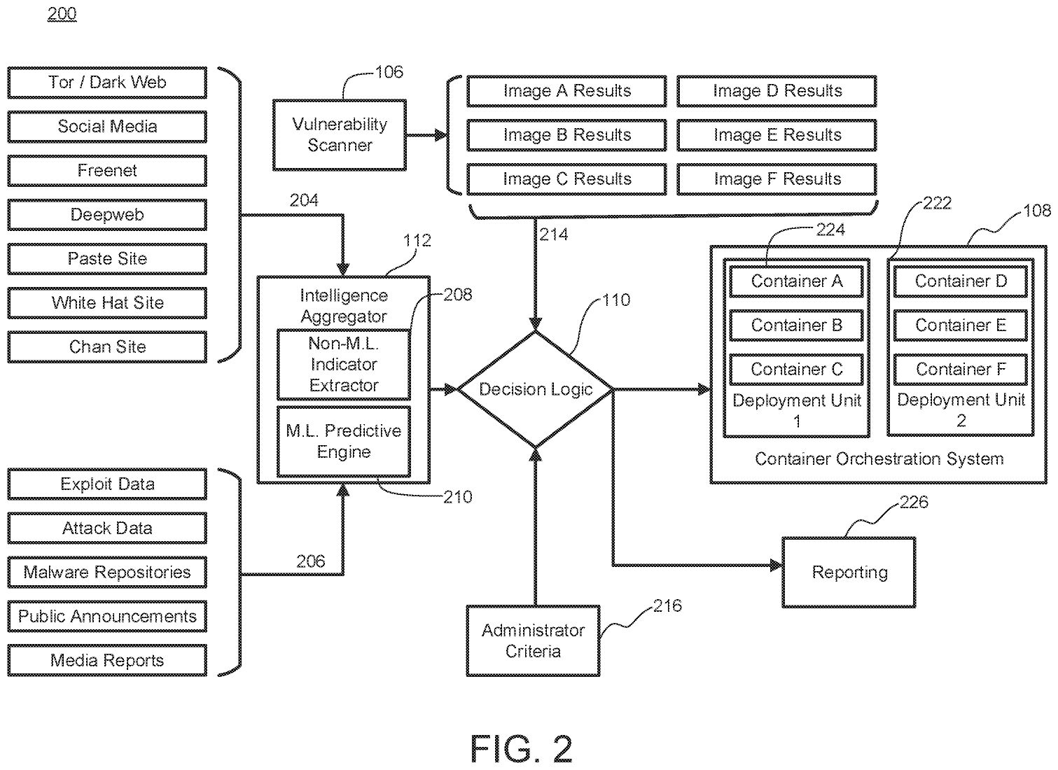

FIG. 2 illustrates a system for identifying and mitigating cybersecurity threats to containers by preventing vulnerable containers from launching, in accordance with various embodiments;

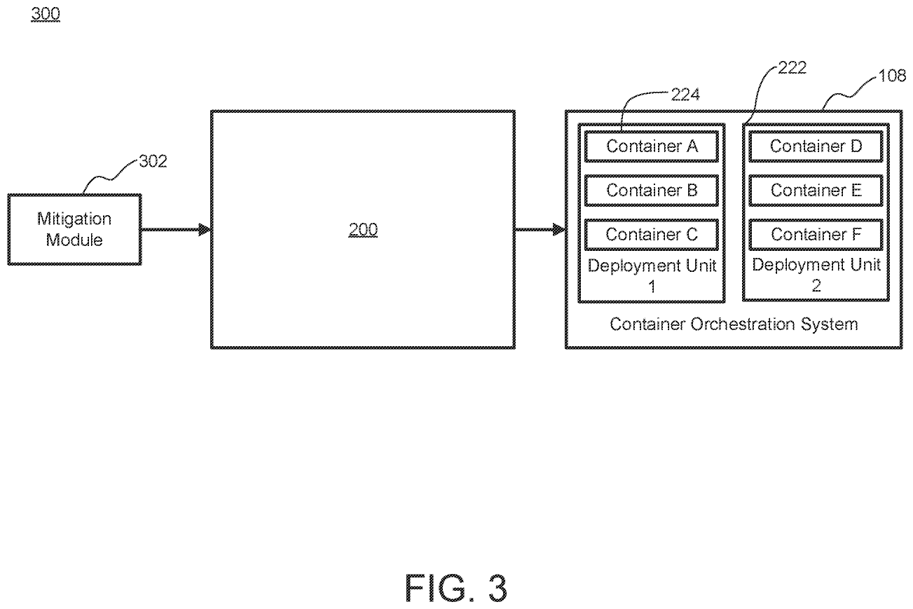

FIG. 3 illustrates a system for mitigating the risk in launching a container subject to cybersecurity threat by performing a mitigating action, in accordance with various embodiments;

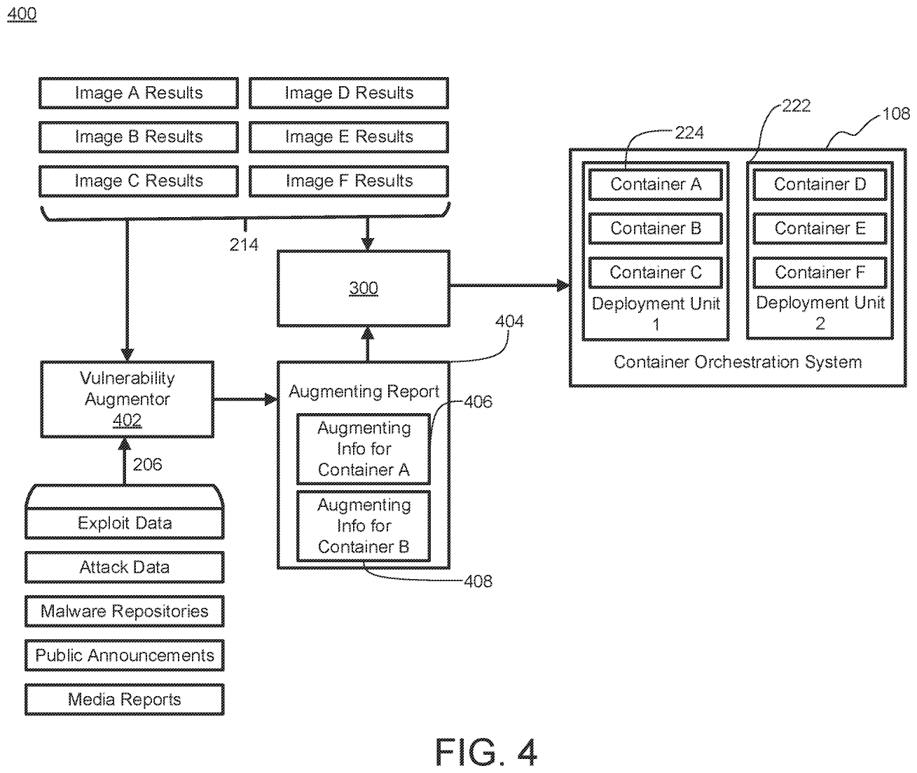

FIG. 4 illustrates a system for augmenting container vulnerability information to anticipate and mitigate cybersecurity threats to containers, in accordance with various embodiments; and

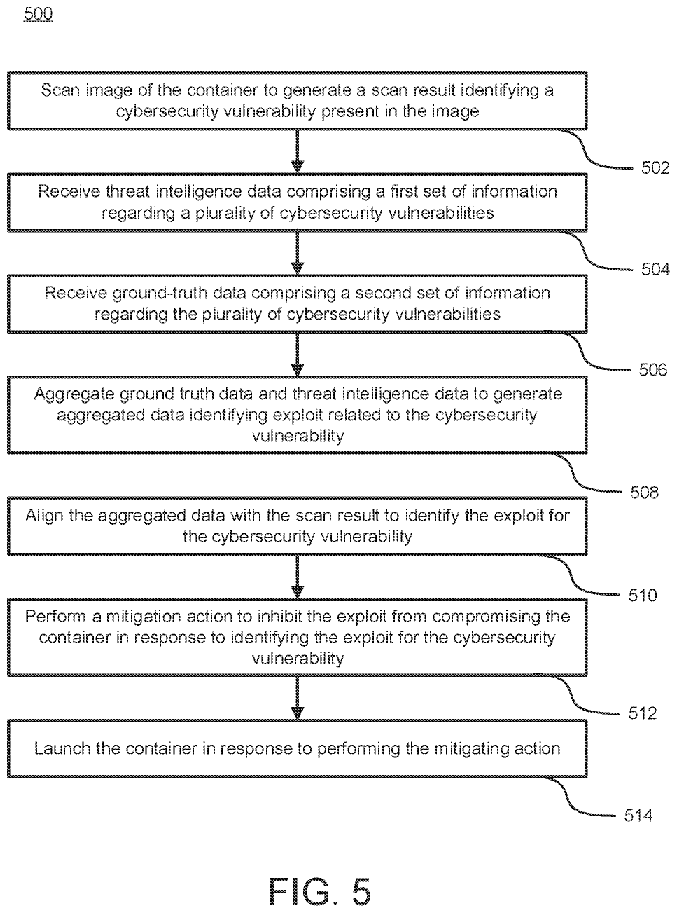

FIG. 5 illustrates a process for detecting and mitigating cybersecurity threats to containers, in accordance with various embodiments.

### DETAILED DESCRIPTION

The detailed description of exemplary embodiments herein refers to the accompanying drawings, which show exemplary embodiments by way of illustration and their best mode. While these exemplary embodiments are described in sufficient detail to enable those skilled in the art to practice the inventions, it should be understood that other embodiments may be realized, and that logical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Systems, methods, and devices (collectively, “Systems”) of the present disclosure detect and/or mitigate cybersecurity vulnerabilities applicable to containers before launching the container. Systems and methods of the present disclosure may use threat information to mitigate vulnerabilities in containers. Machine learning or non-machine learning decisioning logic may make detection and mitigation decisions. Reporting and administration components may enable administrators to supply criteria to the decision logic layer and read results and status reports. Systems of the present disclosure may thus prevent, limit, restrict, and/or recording the deployment of containers that have either confirmed or predicted threats based on criteria to trigger different mitigation actions.

As used herein, the term “Common Vulnerabilities and Exposures” (CVE) refers to a unique identifier assigned to each software vulnerability reported in the National Vulnerability Database (NVD) as described at https://nvd.nist.gov (last visited Jun. 16, 2020). The NVD is a reference vulnerability database maintained by the National Institute of Standards and Technology (NIST). The CVE numbering system typically follows a numbering formats such as, for example, CVE-YYYY-NNNN or CVE-YYYY-NNNNNNN where the “YYYY” indicates the year in which the software flaw is reported, and the N's is an integer identifying a flaw. For example, CVE-2018-4917 identifies an Adobe Acrobat flaw and CVE-2019-9896 identifies a PuTTY flaw.

As used herein, the term “Common Platform Enumeration” (CPE) refers to a list of software/hardware products that are vulnerable to a given CVE. The CVE and the respective platforms affected (i.e., CPE data) can be obtained from the NVD. For example, the following CPE's are some of the CPE's vulnerable to CVE-2018-4917:
cpe:2.3:a:adobe:acrobat_2017:*:*:*:*:*:*:*:*
cpe:2.3:a:adobe:acrobat_reader_dc:15.006.30033:*:*:*:classic:*:*:*
cpe:2.3:a:adobe:acrobat_reader_dc:15.006.30060:*:*:*:classic:*:*:*

With reference to FIG. 1, a computer-based system 100 is shown for detecting and mitigating threats in containers, in accordance with various embodiments. The system 100 may comprise a computing and networking environment suitable for implementing aspects of the present disclosure. In general, the system 100 includes at least one computing device 102, which may be a server, controller, a personal computer, a terminal, a workstation, a portable computer, a mobile device, a tablet, a mainframe, other suitable computing devices either operating alone or in concert. System 100 may include a plurality of computing devices connected through a computer network 104, which may include the Internet, an intranet, a virtual private network (VPN), a local area network (LAN), or the like. A cloud (not shown) hardware and/or software system may be implemented to execute one or more components of the system 100.

In various embodiments, computing device 102 may comprise computing hardware capable of executing software instructions through at least one processing unit. Moreover, the computing device and the processing unit may access information from one or more data sources including threat-intelligence data sources 114 and ground-truth data sources 116 of real-world attack patterns. Computing device 102 may further implement functionality associated predicting threats to various technologies related to associated vulnerabilities defined by various modules such as a vulnerability scanner 106, a container orchestration system 108, a decision logic layer 110, and an intelligence aggregator 112. Components of computer-based system 100 are described in greater detail below.

Referring now to FIG. 2, system 200 for detecting and mitigating threats in containers is shown, in accordance with various embodiments. System 200 may collect threat information including ground-truth data 206 and threat-intelligence data 204. Intelligence aggregator 112 may collect and correlate ground-truth data 206 and threat-intelligence data 204 to identify relevant threat intelligence to vulnerabilities in the images used by containers using an indicator extractor 208 and/or a machine learning predictive engine 210. The indicator extractor may obtain indicators from threat intelligence that can be used as decision criteria. Various techniques may be used to extract indicators from threat intelligence such as, for example, regular expression matching, pattern matching, entity extraction, natural language processing (NLP). Extracted indicators may include items such as, for example, availability of an exploit for a particular vulnerability, the vulnerability being of interest to part of the hacking community, proof-of-concept code for a vulnerability being available, or other various pieces of metadata relating to either the vulnerability itself or aspects of intelligence relating to threats associated with vulnerability. The machine learning predictive engine may either use threat intelligence and ground-truth data directly or leverage indicators as described above to create predictions as to which vulnerabilities will be exploited. Threat intelligence data 204 may be obtained from sources such as, for example, TOR, social media, freenet, deepweb, paste sites, chan sites, or other suitable original source types. Ground-truth data 206 may include exploit data, attack data, malware repositories, public announcements, or media reports, for example.

In various embodiments, threat-intelligence data 204 and/or ground-truth data 206 may include text content that relates to certain technology types. Different techniques may be used to identify the discussed technology from the text if present in various embodiments. System 100 may extract the technology using NLP techniques to identify software names or using regular expressions to identify software discussed. NLP techniques may include, for example, using Word2vec or other neural network techniques to find words from hacker discussions that are similar to software names. In another example, CVEs and CPEs may be processed to extract affected technology for checking against container images or installed software lists. Regular expressions may also identify patterns in text such as, for example, names and/or versions of software products. Intelligence aggregator 112 may ingest raw intelligence and arrive at various decision criteria based on both machine learning and non-machine learning methods.

In various embodiments, intelligence aggregator 112 may use intelligence information from various sources predict if a vulnerability will be exploited. Intelligence aggregator 112 may also predict other aspects of a vulnerability such as, for example, the release of a penetration testing module. Intelligence aggregator 112 may also collect and use metadata about a vulnerability such as, for example, whether a vulnerability is wormable, has an active exploit, has exploit code available, or other metadata suitable for checking against administrator criteria 216 to make deployment or mitigation decisions.

In various embodiments, decision logic layer 110 may receive ingested and preprocessed intelligence data from intelligence aggregator 112 regarding the various containers 224 that container orchestration system 108 can deploy. Decision logic layer 110 may comprise a software program running on a computing device. Decision logic layer 110 may run on the same computing device that receives administrative criteria 216 as input from a user. Administrative criteria 216 may be expressed in the system as logical rules. The results of the intelligence aggregator 112 may detect whether criteria specified in the administrative criteria 216 have been met. The results from intelligence aggregator 112, whether generated by non-M.L. indicator extractor 208 or M.L. predictive engine 210, are delivered to the decision logic layer 110 in an atomic fashion whereby certain indicators or predictions will cause certain Administrative criteria to be true or false for a given container on the verge of deployment. In this case, the decision logic layer 110 determines if the container is permitted to deploy and/or further actions (e.g., reporting) are also required.

In various embodiments, vulnerability scanner 106 may scan images used to launch containers 224. Vulnerability scanner 106 may send scan results 214 for each scanned image to decision logic layer 110. Vulnerability scanner 106 may perform periodic scans of the images associated with containers 224 at predetermined intervals or in real-time.

In various embodiments, vulnerability scanner 106 may comprise a commercially available, custom, or open source tool such as, for example, the scanner named Clair and available at https://coreos.com/clair/docs/latest/ (last visited Nov. 2, 2020). Scan results 214 may be stored in a database or file system for retrieval or delivery to decision logic layer 110. For example, results from vulnerability scanner 106 may be stored in a document database, a relational database, a flat file, a structured file, or an unstructured data store. The results of the scanner may be transmitted to the decision logic layer 110 on-the-fly or cached in advance of decision logic layer 110 evaluating the images for vulnerabilities.

In various embodiments, decision logic layer 110 may receive and/or retrieve scan results 214 from vulnerability scanner 106 and aggregated intelligence data from intelligence aggregator 112. Decision logic layer 110 may determine whether images for containers 224 are subject to cybersecurity threats by applying predetermined or dynamically determined criteria to the aggregated intelligence data and the results from the vulnerability scanner. Decision logic layer 110 may receive administrator criteria 216 input by a system administrator specifying criteria under which a container may not deploy, may deploy under certain restrictions, or which deployment should be logged as being susceptible to a threat. System 200 may have default administrator criteria enabled absent input from an administrator selecting criteria.

In various embodiments, decision logic layer 110 may align the scan results 214 with the aggregated information from intelligence aggregator 112 to identify threats relevant to the vulnerabilities in a given container 224. Intelligence aggregator 112 may tag and sort intelligence data by vulnerability to facilitate alignment. Methods for aligning intelligence with vulnerabilities include using direct references to vulnerabilities in the intelligence (e.g., hacker discussion that include a given CVE number). Techniques suitable for aligning intelligence with vulnerabilities may also include using automated tagging (e.g., natural language processing techniques and/or off-the-shelf entity extractors such as TextRazor or IBM® Alchemy). Other techniques to align intelligence data with vulnerabilities include using an off-the-shelf product that pre-aligns intelligence to vulnerabilities (i.e. CYR3CON®, Recorded Future®, SixGill®, etc.). The threats relevant to each container may be referred to as threat criteria for the container 224. Decision logic layer 110 may compare threat criteria for a given container against the administrator criteria 216 to determine whether the container 224 should launch, launch with restrictions, launch with mitigating controls in place, launch with expanded logging, or be blocked from launching.

Examples of threat criteria include thresholds on relative likelihood of a threat actor using a vulnerability in an attack, “severity” scores for vulnerabilities determined by various means, scoring for software vulnerabilities based on industry standards such as NIST CVSS, the type of software weakness used by the vulnerability (i.e. the associated NIST CWE's). Examples of software weaknesses include SQL injection, XSS, etc. Examples of threat criteria may also include the types of software leveraged by the vulnerability (such as the associated NIST CPE's). Examples of software leveraged by a vulnerability may include, for example, Windows, Linux, IOS, Apache Struts, etc. Additional examples of threat criteria may include various pieces of metadata concerning the vulnerability such as if the vulnerability is wormable, is a remote code execution (RCE) vulnerability, is a local privilege escalation (LPE) vulnerability, or has other characteristics of interest.

Examples of threat criteria may also include, whether there is an active exploit in the wild for the vulnerability, whether there is an indicator of compromise (IOC) for malware that exploits the vulnerability, whether there is mass exploitation or scanning for vulnerability, whether there is a penetration testing module (such as Metasploit module) for the vulnerability, whether there is a proof-of-concept (POC) code for the vulnerability (such as one available from ExploitDB, PacketStorm, or similar source). Additional threat criteria examples include whether the vulnerability is in the OWASP top 10, if the system with the vulnerability has certain characteristics, a combination of the above factors, or other suitable data indicating a threat to a container.

For example, suppose an image for Container A has CVE-2017-143 (EternalBlue). Intelligence aggregator 112 reports that there is an active exploit for this vulnerability. If the administrator criteria 216 is set to block all container deployments in response to an active exploit, then the decision logic layer instructs container orchestration system 108 not to deploy the vulnerable container. Decision logic layer 110 may use information from intelligence aggregator 112 to drive such decisions.

In various embodiments, decision logic layer 110 may communicate with a container orchestration system (e.g., Kubernetes®) to control launching of containers 224 in container deployment units 222 (e.g., a pod in Kubernetes®). Decision logic layer may direct container orchestration system 108 to launch or prevent launch of a container 224 in response to the container 224 being subject to a vulnerability known or predicted by decision logic layer 110.

In another example, intelligence aggregator 112 obtains information from common sources such as NIST NVD, ExploitDB, and Metasploit and/or intelligence information from solutions such as CYR3CON® or Recorded Future®. Intelligence aggregator 112 uses a vulnerability prioritization algorithm such as that provided by CYR3CON®, Tenable®, or Kenna® to retrieve additional data and/or criteria suitable used for use in decisions. Administrator criteria 216 is entered via web form with the output stored in JSON. Decision logic layer 110 may read the administrator criteria 216 from the JSON file and compare the criteria with the scan results 214 and aggregated intelligence data from and intelligence aggregator 112. The decision logic layer combines the foregoing information in the present example and instructs container orchestration system 108 such as Kubernetes®, which then implements the decision to deploy or not deploy a container.

In various embodiments, decision logic layer 110 may record decisions and output through a reporting interface 226 in a report format. The report format may be a human-readable form, json, html, xml, or another format suitable for input into a Security Information and Event Manager (SIEM), such as Splunk. Reporting interface 226 may output reports in an electronic file format suitable for further use by system 200. Reporting interface 226 may report results back to decision logic layer 110 to form a feedback loop, for example. Reporting interface 226 may record administrator criteria 216 as used by the decision logic layer may record scan results 214 from vulnerability scanner 106 along with the resulting decision to launch container 224, restrict launch or container 224, or otherwise mitigate a threat to container 224.

Referring now to FIG. 3, system 300 for detecting and mitigating cyber security risks is shown, in accordance with various embodiments. System 300 may include some or all components of system 200 of FIG. 2. System 300 may mitigate cyber security risks in container response to a scan result 214 (of FIG. 2) meeting an administrator criteria 216. In that regard, system 300 may comprise additional features relative to system 200 to implement work arounds and mitigating controls for cybersecurity vulnerabilities to containers 224 that may reduce the likelihood of exploitation and/or impact if exploited. System 300 may thus mitigate the risk of launching a container 224 that is subject to a known or predicted vulnerability.

In various embodiments, mitigation module 302 may store or retrieve information regarding a vulnerability and suitable mitigating actions from sources such as, for example, the National Vulnerability Database (NVD) maintained by the National Institute of Standards and Technology (NIST), China's National Vulnerability Database (CNNVD), Exploit databases such as ExploitDB, or other sources for vulnerability information. Information related to a vulnerability and relevant to mitigation may include, for example, a list of ports used to exploit a vulnerability, IOC for common attack methods exploiting the vulnerability, known or predicted IP addresses used in exploiting the vulnerability, signatures of malware that leverage exploits against the vulnerability, software that causes the vulnerability to be realized, or other information suitable for use in mitigating the risk of exploit for a vulnerability.

In various embodiments, mitigation actions may be associated with each piece of information for implementation. Mitigating actions or workarounds may include, for example, blocking ports, deploying an alternate container in the container deployment unit, blocking IP addresses, blocking signatures of malicious software, taking actions dictated by an IOC, disabling software within a container that induces the vulnerability, patching the container in a secure environment and reimaging, or other actions suitable to mitigate the risk of exploit posed by a vulnerability. More than one mitigating activity may be taken in response to a piece of information about a vulnerability prior to, during, or after launching container 224 affected by the vulnerability. Mitigation actions associated with each piece of information may be automatically implemented by decision logic layer 110 (of FIG. 2), container orchestration system 108, container deployment unit 222, container 224. The mitigation actions may be specified in various ways. For example, mitigation actions may be specified by the user as part of the criteria. Automated decision criteria may be based on learned best practices that mitigate attacks. Further, action criteria may also be shared among users from different organizations in an online community feed that can be ingested into system 200.

In various embodiments, decision logic layer 110 may instruct cybersecurity assets in electronic communication with system 300 to implement mitigation actions. Examples of cybersecurity assets suitable for implementing mitigating actions may include firewalls, routers, application white lists, application black lists, SIEMs, alarms, packet sniffers, patching tools, imaging tools, routing tables, security appliances, or other cybersecurity assets suitable to limit the risk of running a container 224 that is subject to a known or predicted vulnerability. Mitigating actions may prevent, detect, log, monitor for, and/or respond to attacks thereby reducing the risk of running a vulnerable container. Decision logic layer 110 may instruct container orchestration system 108 or other cybersecurity assets to take mitigating actions.

Referring now to FIG. 4, system 400 is shown for augmenting container vulnerability information to anticipate and mitigate cybersecurity threats, in accordance with various embodiments. System 400 may include some or all components of system 300 (of FIG. 3) and system 200 (of FIG. 2). System 400 may extend the list of vulnerabilities for a given container through new information. In that regard, when a new vulnerability is notified, system 400 does not have to wait for a corresponding update to the vulnerability scanner and the performance of a new vulnerability scan for a given image associated with a container 224.

In various embodiments, vulnerability augmentor 402 may retrieve external information about new vulnerabilities obtained from sources such as, for example, NIST NVD, CNNVD, ExploitDB, or other suitable sources for vulnerability information. The information may include ground-truth data 206 or threat-intelligence data 204. In response to a new vulnerability being identified, vulnerability augmentor 402 may compare the information with the results 214 of recent vulnerability scans for the containers 224 that ran without knowledge of the new vulnerability. New vulnerabilities may or may not be associated with an existing threat.

In various embodiments, vulnerability augmentor 402 may detect that new vulnerability data from one or more sources is related to existing vulnerabilities and/or technology (e.g., software) for an existing container 224, it vulnerability augmentor 402 may create an augmenting report 404 on additional suspected vulnerabilities for the container 224. Vulnerability augmentor 402 may detect whether additional, suspected vulnerabilities are present is by considering aspects of the previously identified vulnerabilities on the system and identifying newer (and not previously detected) vulnerabilities that may be applicable to the same or related software. Vulnerability augmentor may include vulnerabilities in the augmenting report 404 even if the vulnerabilities were not identified in the scan result 214 for the image of the container 224. Decision logic layer 110 (of FIG. 2) may use the information in the augmenting report 404 considered in the system for claim 1 along with the vulnerability data provided by the scanner.

In various embodiments, vulnerability augmentor 402 may predict a new vulnerability for a container 224 based on results 214 from a previous scan using the following exemplary techniques, though other techniques may also be appropriate for detecting and/or predicting new vulnerabilities not present in results 214 of a vulnerability scan. For example, a new or predicted vulnerability may be similar to a vulnerability identified on results 214 for the container 224. In another example, a list of software for the image associated with the container may be maintained with the vulnerability scan, and system 400 may compare the software for the image with a list of vulnerabilities to determine whether a new vulnerability is pertinent to that container 224. In still another example, a list of software may be inferred from the vulnerabilities resulting from scan results 214, and a new vulnerability may be compared to this inferred software. In yet another example, machine learning or similar technology may compare a description of the new vulnerability against information about a container 224. In another example, a manually specified and user-specified criteria about new vulnerabilities may be applied to containers 224 and underlying images.

In various embodiments, augmented vulnerability information may be concatenated with the vulnerability scan associated with a container. Thus, decision logic layer 110 may receive vulnerability information and scan results 214 augmented with potentially new vulnerability information. For example, an augmenting report may contain augmenting information 406 for Container A and separate augmenting information 408 for container B.

Referring now to FIG. 5, a process 500 for detecting and mitigating threats in containers is shown, in accordance with various embodiments. Systems 100, 200, 300, and 400 as depicted and described herein may perform various steps of process 500. A system may scan image of a container to generate a scan result identifying a cybersecurity vulnerability present in the image (Block 502). The system may receive threat intelligence data comprising a first set of information regarding a plurality of cybersecurity vulnerabilities (Block 504). The system may also receive ground-truth data comprising a second set of information regarding the plurality of cybersecurity vulnerabilities (Block 506). The system may then aggregate ground-truth data and threat-intelligence data to generate aggregated data identifying an exploit related to the cybersecurity vulnerability (Block 508).

In various embodiments, process 500 may also include the steps of aligning the aggregated data with the scan result to identify the exploit for the cybersecurity vulnerability (Block 510). A mitigation action may be performed by the system to inhibit the exploit from compromising the container in response to identifying the exploit for the cybersecurity vulnerability (Block 512). The system may launch the container in response to performing the mitigating action (Block 514). Systems and methods of the present disclosure may improve security when launching and running container-based environments by enabling detection, prediction, and/or mitigation of vulnerabilities in container images before the images are used to launch the container.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions.

The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Devices, systems, and methods are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or device that comprises a list of elements does not include only those elements but may include other elements not expressly listed or inherent to such process, method, article, or device.

What is claimed is:

1. A method for detecting cybersecurity threats in a container, comprising:
scanning, by a vulnerability scanner of a computer-based system, an image of the container to generate a scan result identifying a cybersecurity vulnerability present in the image;
receiving, by a computer-based system, threat-intelligence data from a threat-intelligence source comprising a first set of information regarding a plurality of cybersecurity vulnerabilities;
receiving, by the computer-based system, ground-truth data from a ground-truth-data source comprising a second set of information regarding the plurality of cybersecurity vulnerabilities;
aggregating, by the computer-based system, the ground-truth data and the threat-intelligence data to generate aggregated data identifying an exploit related to the cybersecurity vulnerability;
aligning, by the computer-based system, the aggregated data with the scan result to identify the exploit for the cybersecurity vulnerability; and
preventing, by the computer-based system, a container from launching in response to identifying the exploit for the cybersecurity vulnerability.

2. The method of claim 1, further comprising:
performing, by the computer-based system, a mitigation action to inhibit the exploit from compromising the container in response to identifying the exploit for the cybersecurity vulnerability and preventing the container from launching; and
launching, by a container orchestration system of the computer-based system, the container in response to performing the mitigating action.

3. The method of claim 2, wherein the mitigating action comprises blocking a port associated with the exploit.

4. The method of claim 2, wherein the mitigating action comprises disabling a software having the vulnerability from running in the container.

5. The method of claim 2, wherein the mitigating action comprises substituting a replacement image for the image.

6. The method of claim 2, wherein the mitigating action comprises blocking an IP address.

7. The method of claim 2, further comprising selecting, by the computer-based system, the mitigating action from a plurality of mitigating actions in response to the scan result and the aggregated data meeting an administrator criteria associated with the mitigating action.

8. The method of claim 1, wherein aggregating the ground-truth data and the threat-intelligence data comprises:
identifying a new threat in at least one of the threat-intelligence data and the ground-truth data, wherein the scan results for the image lack the new threat; and
determining the new threat is applicable to the image.

9. The method of claim 1, wherein aligning the aggregated data with the scan result comprises at least one of tagging and sorting intelligence data by vulnerability, using direct references to vulnerabilities in the intelligence data, using automated tagging, and using an off-the-shelf product that pre-aligns intelligence to vulnerabilities.

10. A computer-based system for detecting cybersecurity threats in a container, comprising:
a processor; and
a tangible, non-transitory memory configured to communicate with the processor, the tangible, non-transitory memory having instructions stored thereon that, in response to execution by the processor, cause the computer-based system to perform operations comprising:
scanning, by a vulnerability scanner of the computer-based system, an image of the container to generate a scan result identifying a cybersecurity vulnerability present in the image;
receiving, by the computer-based system, threat-intelligence data from a threat-intelligence source comprising a first set of information regarding a plurality of cybersecurity vulnerabilities;
receiving, by the computer-based system, ground-truth data from a ground-truth-data source comprising a second set of information regarding the plurality of cybersecurity vulnerabilities;
aggregating, by the computer-based system, the ground-truth data and the threat-intelligence data to generate aggregated data identifying an exploit related to the cybersecurity vulnerability;
aligning, by the computer-based system, the aggregated data with the scan result to identify the exploit for the cybersecurity vulnerability;
performing, by the computer-based system, a mitigation action to inhibit the exploit from compromising the container in response to identifying the exploit for the cybersecurity vulnerability; and
launching, by a container orchestration system of the computer-based system, the container in response to performing the mitigating action.

11. The computer-based system of claim 10, wherein the mitigating action comprises blocking a port associated with the exploit.

12. The computer-based system of claim 10, wherein the mitigating action comprises substituting a replacement image for the image.

13. The computer-based system of claim 10, wherein the mitigating action comprises blocking an IP address.

14. The computer-based system of claim 10, wherein the mitigating action comprises disabling a software having the vulnerability from running in the container.

15. The computer-based system of claim 10, wherein aggregating the ground-truth data and the threat-intelligence data comprises:
identifying a new threat in at least one of the threat-intelligence data and the ground-truth data, wherein the scan results for the image lack the new threat; and
determining the new threat is applicable to the image.

16. The computer-based system of claim 10, wherein aligning the aggregated data with the scan result comprises at least one of tagging and sorting intelligence data by vulnerability, using direct references to vulnerabilities in the intelligence data, using automated tagging, and using an off-the-shelf product that pre-aligns intelligence to vulnerabilities.

17. A method for detecting cybersecurity threats in a container, comprising:
scanning, by a vulnerability scanner of a computer-based system, an image of a container to generate a scan result identifying a cybersecurity vulnerability present in the image;
identifying, by the computer-based system, an exploit for the cybersecurity vulnerability; and
preventing, by the computer-based system, the container from launching in response to identifying the exploit for the cybersecurity vulnerability.

18. The computer-based system of claim 17, further comprising:
performing, by the computer-based system, a mitigation action in response to identifying the exploit for the cybersecurity vulnerability; and
launching, by a container orchestration system of the computer-based system, the container in response to performing the mitigating action.

19. The computer-based system of claim 18, wherein the mitigating action comprises disabling a software having the vulnerability from running in the container.

20. The computer-based system of claim 18, wherein the mitigating action comprises substituting a replacement image for the image.
